(19) United States
(12) Patent Application Publication
(10) Pub. No.: US 2004/0181943 A1
(43) Pub. Date: Sep. 23, 2004

(54) Shaving systems

(76) Inventor: Michael Kwiecien, Scituate, MA (US)

Correspondence Address: FISH & RICHARDSON PC, 225 FRANKLIN ST, BOSTON, MA, 02110, US

(21) Appl. No.: 10/798,496

(22) Filed: Mar. 11, 2004

Related U.S. Application Data
(60) Provisional application No. 60/455,646, filed on Mar. 18, 2003.

(51) Int. Cl. B26B 19/44

(52) U.S. Cl. 30/41

(57) ABSTRACT

A shaving aid composite includes exfoliating elements or exfoliating material.

### CROSS-REFERENCE TO RELATED APPLICATIONS

This application claims priority from U.S. Provisional Application Serial No. 60/455,646, filed on Mar. 18, 2003, which is incorporated herein by reference in its entirety.

### TECHNICAL FIELD

This invention relates to shaving systems.

### BACKGROUND

In shaving systems of the wet shave type, factors such as the frictional drag of the razor across the skin, the force needed to sever hairs, and irritation of preexisting skin damage can create a degree of shaving discomfort. Discomfort and other problems accompanying wet shaving systems can be alleviated by the application of shaving aids to the skin. Shaving aids may be applied prior to, during, or after shaving.

A number of problems accompany the use of pre- and post-applied shaving aids. Pre-applied shaving aids can evaporate or can be carried away from the site of application by repeated strokes of the razor. Post-applied shaving aids are not present on the skin during shaving and thus their application may be too late to prevent an unwanted effect. Moreover, the application of both pre-applied and post-applied shaving aids adds extra steps to the shaving process.

It is known to incorporate a shaving aid into a razor by mounting a composite including the shaving aid to the razor. For example, Rogers et al., U.S. Pat. No. 5,113,585 describes a composite including a water-insoluble matrix material, a water-soluble shaving aid, and a low molecular weight release enhancing agent. When exposed to water during shaving, the water-soluble shaving aid leaches from the composition onto the skin. The release enhancing agent also dissolves in the water and improves the release of the water-soluble shaving aid from the composite.

### SUMMARY

The invention generally relates to shaving systems with skin-engaging portions that include a shaving aid matrix and exfoliating elements.

In one aspect, the invention features a wet shaving system that includes a blade member and a skin-engaging portion with a shaving aid composite. The shaving aid composite includes a shaving aid matrix having a polymer (e.g., a water-insoluble polymer) and a shaving aid. The shaving aid composite also includes a plurality of exfoliating elements that are embedded in the shaving aid matrix.

In another aspect, the invention features a wet shaving system having a blade member and a skin-engaging portion. The skin-engaging portion includes a shaving aid composite having a first section that includes a first polymer (e.g., a water-insoluble polymer) and a plurality of exfoliating elements embedded in the first polymer, and a second section that includes a second polymer (e.g., a water-insoluble polymer). At least one of the first section or the second section further has a shaving aid.

In some embodiments, at least one of the first polymer and the second polymer is water-insoluble. In some cases, the second section has a plurality of exfoliating elements embedded in the second polymer. Both the first section and the second section can comprise a shaving aid. The first section can include a shaving aid. The second section can include a shaving aid. The first section can be on top of the second section or can be laterally adjacent to the second section. In some embodiments, the first and second sections are different colors. At least one of the first section or the second section can include a colorant.

In another aspect, the invention features a shaving aid composite including a shaving aid matrix with a polymer, a shaving aid, and a plurality of exfoliating elements. The exfoliating elements are embedded in the shaving aid matrix.

In some embodiments, the polymer is water-insoluble.

In another aspect, the invention features a shaving aid composite including a first section with a first polymer and a plurality of exfoliating elements embedded in the first polymer, and a second section with a second polymer. At least one of the first section or the second section further includes a shaving aid.

In some embodiments, at least one of the first polymer or the second polymer is water-insoluble.

In another aspect, the invention features a shaving aid composite having a water-insoluble polymer, a shaving aid, and a plurality of exfoliating elements.

In some embodiments, the shaving aid and the exfoliating elements are disposed in a single layer. In some cases, the shaving aid is disposed in a first portion of the water-insoluble polymer, and the exfoliating elements are disposed in a second portion of the water-insoluble polymer.

In another aspect, the invention features a wet shaving system with a blade member and a skin-engaging portion. The skin-engaging portion of the wet-shaving system includes a shaving aid composite and an exfoliating material (e.g., a mesh or net material). The shaving aid composite includes a shaving aid matrix including a polymer and a shaving aid.

In some embodiments, the exfoliating material is embedded in a skin-engaging portion of the shaving aid matrix. In certain embodiments, the shaving aid matrix is molded over the exfoliating material.

In any of the above aspects, one or more of the following features may also be included. In some embodiments, the exfoliating elements are fruit seeds, fruit stones, nut shells, ground or fibrous plant material, polymers, mineral composites, or combinations thereof. In some cases, the exfoliating elements are ground coconut shells, ground apricot seeds, ground peach seeds, ground olive seeds, ground walnut shells, ground almond shells, ground pecan shells, ground luffa, corn cob granules, ground oatmeal, polymer beads or granular polymers, Jojoba wax beads, rice bran, silica, sand, or other minerals, pumice sand, clay, or combinations thereof. The exfoliating elements can be microcapsules, with each microcapsule defining an external surface and an internal volume. In some cases, the internal volumes of the microcapsules contain a chemical exfoliant, such as an alpha-hydroxy acid or a beta-hydroxy acid. In some cases, the external surfaces of the microcapsules include an exfoliant. Alternatively or additionally, the external surfaces of the microcapsules can include a shaving aid. The shaving aid can be polyethylene oxide. The shaving aid can be vitamin E, aloe, baby oil, avocado oil, grape seed oil, or sweet almond oil. In some embodiments, the exfoliating elements include a colorant. The polymers can be polyethylene, polypropylene, polystyrene, butadiene-styrene copolymer, polyacetal, polycaprolactone, nylon, acrylonitrile-butadiene-styrene copolymer, polycarbonate, polyurethane, and/or ethylene vinyl acetate copolymer. The shaving aid composite can further include a colorant.

Embodiments may include one or more of the following advantages. Exfoliation can improve the look and feel of the skin. By delivering a lubricating or moisturizing material to the skin during exfoliation, the potential for discomfort from exfoliation, e.g., in sensitive shaving areas, can be decreased or even eliminated. Time spent on skin care can be reduced, since the user can exfoliate and shave simultaneously. The exfoliating material can help to release hairs trapped just below the follicle. Furthermore, the exfoliating material can favorably orient the hairs just before the hairs are cut by the razor blades, leading to a closer and more efficient shave.

Other features and advantages of the invention will be apparent from the description and drawings, and from the claims.

### DESCRIPTION OF DRAWINGS

FIG. 1 is a perspective view of an embodiment of a razor unit with a shaving aid composite.

FIG. 2 is a top view of an embodiment of a shaving aid composite.

FIG. 3 is a top view of an embodiment of a shaving aid composite.

FIG. 3A is a perspective view of the shaving aid composite of FIG. 3.

FIG. 3B is a cross-sectional view of the shaving aid composite of FIG. 3A.

FIG. 4 is a perspective view of an embodiment of a shaving aid composite.

FIG. 5 is a top view of an embodiment of a shaving aid composite.

FIG. 6 is a perspective view of an embodiment of a shaving aid composite.

FIG. 7 is a perspective view of an embodiment of a razor unit with a shaving aid composite.

FIG. 8 is a perspective view of an embodiment of a razor unit with multiple shaving aid composites.

FIG. 9 is a perspective view of an embodiment of a razor unit with a shaving aid composite.

FIGS. 10-12 are perspective views of embodiments of a shaving aid composite.

### DETAILED DESCRIPTION

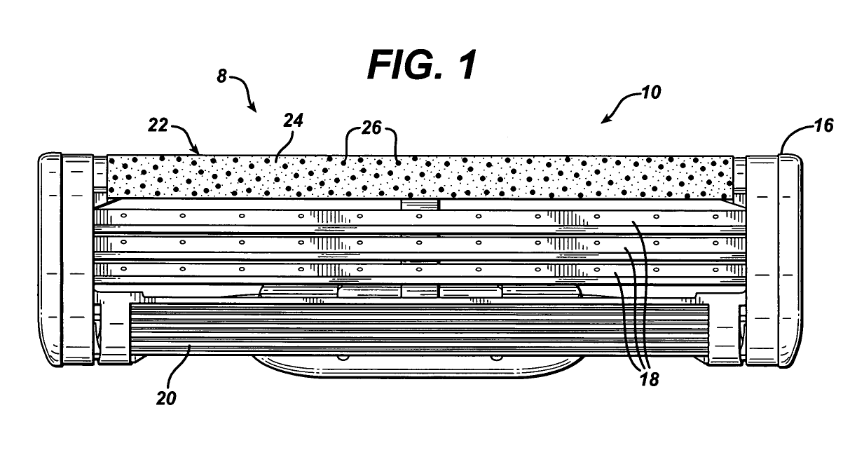

Referring to FIG. 1, a wet shaving system 8 includes a replaceable shaving cartridge 10 of the type shown in U.S. Pat. No. 5,787,586, which is assigned to the same assignee as the present application and is hereby incorporated by reference. While the wet shaving system 8 of FIG. 1 includes a replaceable cartridge, in some embodiments it can include a shaving head which is integral with a razor handle so that the complete razor is discarded as a unit when the blade or blades become dulled.

Shaving cartridge 10 includes a housing 16, which carries three blades 18, a guard 20, and a shaving aid composite 22, which is in the form of an elongated insert member. The shaving aid composite is locked in an opening in the rear of the cartridge and includes a shaving aid matrix 24 and exfoliating elements 26. In FIG. 1, the exfoliating elements are embedded in the shaving aid matrix. Depending on the matrix material used, the exfoliating elements may be released by the composite during shaving, e.g., by erosion of the matrix, or may remain in place during shaving.

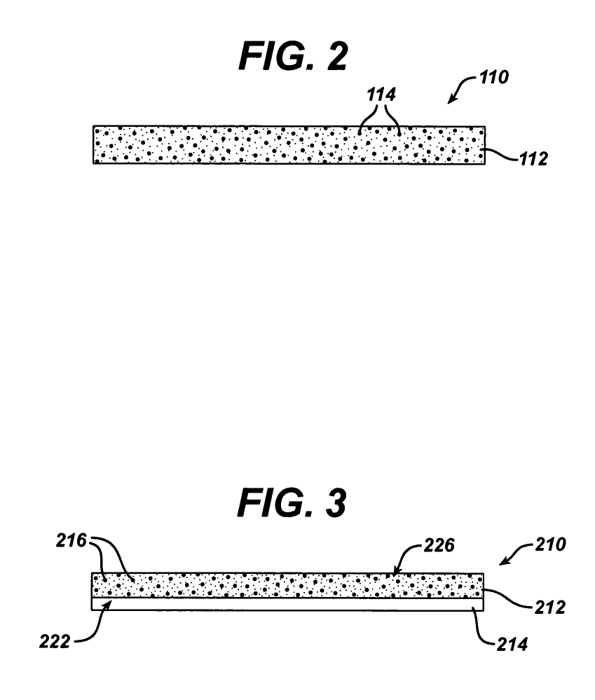

Referring to FIG. 2, a shaving aid composite 110 is shown. Shaving aid composite 110 includes a lubricating or moisturizing shaving aid matrix 112 (e.g., a polymer blend) in which are embedded exfoliating elements 114. Exfoliating elements 114 are embedded throughout shaving aid matrix 112.

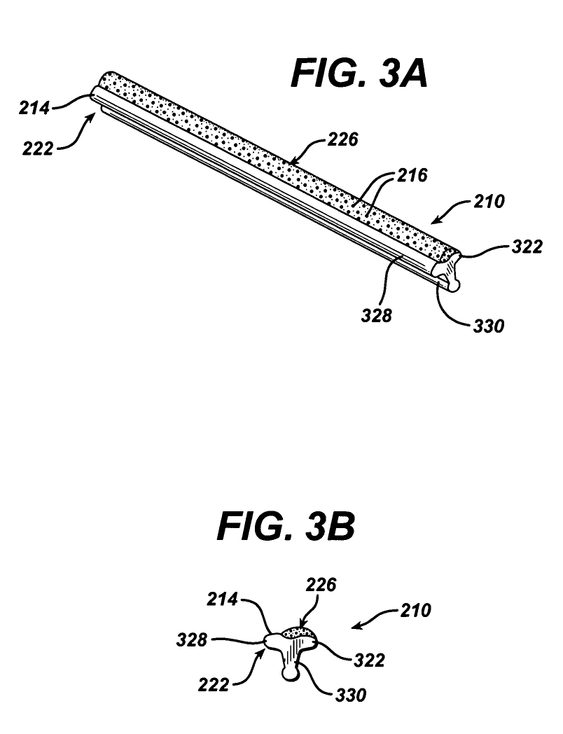

FIG. 3 shows a shaving aid composite 210 with an exfoliating portion 226 that includes a polymeric matrix 212 and exfoliating elements 216 embedded in the matrix, and a shaving aid portion 222 that includes a lubricating or moisturizing shaving aid matrix 214. Exfoliating portion 226 is disposed on top of shaving aid matrix 214, but does not cover the entire surface of the matrix. Exfoliating portion 226 can occupy, for example, approximately ⅔ of the surface of shaving aid matrix 214. Thus, the exposed surface of shaving aid matrix 214 is available for release of the shaving aid to the user's skin during shaving.

The exfoliating portion 226 may contain, e.g., exfoliating particles dispersed in a matrix consisting of a hard polymer such as styrene, without any shaving aid, while the shaving aid matrix 214 contains a matrix of hard polymer (the same polymer or a different polymer) and a shaving aid. Alternatively, both the exfoliating layer and the shaving aid matrix may contain a shaving aid. In such cases, the exfoliating layer may contain the same shaving aid as the shaving aid matrix, or the exfoliating layer and the shaving aid matrix may contain different shaving aids. The matrix compositions of the exfoliating portion and shaving aid portion will be discussed in detail below.

Referring to FIGS. 3A and 3B, shaving aid portion 222 includes lengthwise-extending portions 322 and 328. Composite 210 also includes connecting portion 330, which connects portions 322 and 328, and which optionally serves to lock the composite into a mating receiving portion of the cartridge.

Portions 322 and 328 and connecting portion 330 together surround all but the exposed surface of portion 226 and thus provide support for portion 226. Portions 322, 226, and 328 each may be, for example, between about 1.20 inches and about 1.35 inches (more preferably between about 1.25 inches and about 1.275 inches) in length, and between about 0.07 inch and about 0.11 inch (more preferably between about 0.085 inch and about 0.095 inch) in width. Portions 322, 226, and 328 each contain a polymeric matrix, e.g., of a water-insoluble polymer as will be discussed below. The water-insoluble polymer in each portion may be different from, or the same as, the water-insoluble polymers in the other portions. Furthermore, each portion may have a shaving aid, and the shaving aid in one portion may be different from, or the same as, the shaving aids in the other portions.

Exfoliating elements 216 can include abrasive particles, for example, ground fruit seeds and stones (e.g., apricot, peach, avocado, or olive seeds or stones), ground nut shells (e.g., walnut, almond, coconut, or pecan shell), ground or fibrous plant material (e.g., luffa, corn cob, oatmeal), polymer beads or granular polymers (e.g., polystyrene beads, polyethylene beads), Jojoba wax beads, rice bran, silica, minerals, granular mineral composites (e.g., sand, pumice sand), clay, or combinations thereof. The exfoliating elements can be dissolvable. The exfoliating elements can be materials (e.g., sea salt) that are abrasive upon first contact with the user's skin, but that later dissolve upon contact with water or shave creams and gels. In some embodiments, the exfoliating elements can be bioerodible (e.g., such that they erode upon contact with the skin).

Alternatively or additionally, exfoliating elements 216 may include chemical exfoliants such as alpha- or beta-hydroxy acids (e.g., citric acid, lactic acid, glycolic acid, tartaric acid). In such cases, the chemical exfoliants can be contained in a microcapsule that breaks during shaving, thereby releasing the exfoliant. In this case, it is generally desirable to use a matrix material that erodes or dissolves during shaving, so that new microcapsules will be exposed to replace those that have ruptured. Suitable microcapsules can range in size from less than about 50 microns to about 1000 microns. Microencapsulation can help to protect the exfoliant, e.g., by protecting heat-sensitive acids from decomposition during extruding or molding operations.

Generally, suitable exfoliating elements have a hardness, roughness, and/or tackiness that is sufficient to allow the exfoliating element to remove loose flakes of skin during shaving. The exfoliating elements can be sufficiently hard so that they do not break down during shaving, or may be softer if desired.

The exfoliating elements can be particles with a diameter between about 2 μm and about 1000 μm (e.g., between about 200 μm and about 500 μm), and an aspect ratio between about 1 and about 2 (i.e., spherical to oblong). The exfoliating elements may have the dimensions of a fiber, such as powdered luffa fibers, in which case they will have aspect ratios that are much greater than 2. In some embodiments, the exfoliating elements in the shaving aid composite are of generally uniform size. In other embodiments, the exfoliating elements in the shaving aid composite are of different sizes.

The shaving aid composite may include between about 5% and about 90% exfoliating elements (e.g., between about 10% and about 60% exfoliating elements, about 10% exfoliating elements). These percentages are by weight, based on the total weight of the exfoliating elements and the polymeric matrix (polymer and, optionally, shaving aid and other additives) in which the exfoliating elements are dispersed. Thus, for example, a composite containing 40% exfoliating elements would contain 60% of a polymeric matrix, which includes a polymer, e.g., a water-insoluble polymer or a blend of water-soluble and water-insoluble polymers, and one or more shaving aids, and may optionally include other additives.

The shaving aid matrix 24 shown in FIG. 1 contains a water-insoluble polymer (e.g., a highly moldable water-insoluble polymer, such as polystyrene or polypropylene) and a shaving aid. In the implementation shown in FIG. 1, the exfoliating elements and shaving aid are included together in a single composition, i.e., the exfoliating elements are dispersed in a matrix that contains a shaving aid. The shaving aid can be released over time. Shaving aid composites in which a shaving aid is released over time are disclosed, e.g., in U.S. Pat. No. 6,442,839, the entire contents of which are hereby incorporated by reference. The exfoliating material can also be released over time, as discussed below. While shaving aid matrix 24 includes a water-insoluble polymer, in some embodiments, a shaving aid matrix of a shaving aid composite does not include any water-insoluble polymers. For example, a shaving aid matrix can be formed substantially of a shaving aid and can be essentially free of water-insoluble polymers.

In implementations that include separate exfoliating and lubricating portions, e.g., as shown in FIG. 3 and discussed above, the matrix in which the exfoliating elements are embedded may contain a lower level of shaving aid than the lubricating portion, or may be entirely free of shaving aid if desired. The presence of shaving aid in the water-insoluble matrix tends to weaken the matrix and make it more easily erodible. Thus, reducing or eliminating the shaving aid in the matrix of the exfoliating portion will generally cause the exfoliating portion to more permanently retain the exfoliating elements. If it is desired that the exfoliating elements be released during shaving, then the shaving aid can be incorporated into the exfoliating portion to render it more easily erodible. In some embodiments, a shaving aid matrix (e.g., the exfoliating portion of a shaving aid matrix) can be modified to enhance its erodibility. For example, polycaprolactone can be added to a shaving aid matrix that contains polystyrene and/or a polyethylene oxide (e.g., POLYOX polymer), to enhance the erodibility of the shaving aid matrix. Alternatively or additionally, the exfoliating elements can be embedded in a matrix material that is inherently erodible. For example, the exfoliating elements can be embedded in a shaving aid matrix that includes one or more hard soaps or waxes. The shaving aid matrix can be substantially formed of the hard soap(s) and/or wax(es), and can be substantially free of water-insoluble polymer(s).

Suitable water-insoluble polymers include polyethylene, polypropylene, polystyrene, butadiene-styrene copolymer (e.g., medium and high impact polystyrene), polyacetal, polycarbonate, polycaprolactone, nylon, polyurethane, acrylonitrile-butadiene-styrene copolymer, ethylene vinyl acetate copolymer and blends such as polypropylene/polystyrene blend.

As an example, a shaving aid matrix can include a mixture of polycaprolactone (e.g., 5% by weight), polyethylene oxide (e.g., 75% by weight), and polystyrene (e.g., 20% by weight).

As discussed above, the shaving aid matrix consists of a polymer, a shaving aid, and, optionally, other additives. A shaving aid matrix can include up to about 95% by weight (e.g., between about 5% by weight and about 95% by weight) water-insoluble polymer, and/or between about 5% by weight and about 95% by weight (e.g., about 20% by weight) shaving aid. Preferably, a shaving aid matrix includes between about 5% by weight and about 85% by weight, more preferably between about 5% by weight and about 50% by weight, even more preferably between about 15% by weight and about 40% by weight, even more preferably between about 20% by weight and about 35% by weight, and most preferably between about 25% by weight and about 30% by weight, of the water-insoluble polymer. In some embodiments, one or more shaving aids make up the balance of the matrix composition. Thus, for example, a shaving aid matrix containing about 50% polymer can contain about 50% shaving aid (with minor amounts of other ingredients, such as antioxidants and/or colorants). In certain embodiments, a shaving aid matrix can include from about 65% by weight to about 80% by weight of a water-insoluble polymer. A preferred water-insoluble polymer is polystyrene, preferably a general purpose polystyrene such as Nova C2345 polystyrene, or a high impact polystyrene (i.e. polystyrene-butadiene), such as BASF 495F polystyrene. The shaving aid matrix should contain a sufficient quantity of water-insoluble polymer to provide adequate mechanical strength, both during production and use.

In implementations in which the matrix of the exfoliating portion does not contain a shaving aid, the matrix can consist of the water-insoluble polymer and any other desired additives.

Suitable shaving aids will be discussed below.

The shaving aid matrix may also contain conventional shaving and composite ingredients. For example, the shaving aid matrix may include low molecular weight water-soluble release enhancing agents such as polyethylene glycol (e.g., between about 1% and about 10% by weight), colorants, antioxidants and/or preservatives. Water-soluble release enhancing agents are described in U.S. Pat. No. 5,113,585, which is hereby incorporated by reference.

Colorant may be included in the shaving aid composite. A shaving aid matrix may contain, for example, between about 0.1% and about 8.0% (e.g., between about 0.5% and about 4.0%) colorant by weight. In some embodiments, the colorant can be used to indicate the type of exfoliating element included in the shaving aid composite. For example, a green colorant may be used to indicate the presence of avocado stone granules as exfoliating elements.

Suitable shaving aids include substances that enhance shaving performance. The shaving aid may, for example, improve shaving comfort (e.g., by lubricating the skin, increasing shaving efficiency, conditioning the beard, or conditioning the skin). Examples of shaving aids include lubricous water-soluble polymers such as polyethylene oxide, polyvinyl pyrrolidone, polyacrylamide, hydroxypropyl cellulose, polyvinyl imidazoline, and polyhydroxyethylmethacrylate; beard hair softeners; oils such as silicone oil, mineral oil, baby oil, avocado oil, grape seed oil, and sweet almond oil; substances that enhance the healing or stop the bleeding of the skin; essential oils such as menthol, eugenol, eucalyptol, safrol, and methyl salicylate; rinsing aids; non-volatile cooling agents; inclusion complexes of skin-soothing agents with cyclodextrin; fragrances; vitamin E (including common forms of vitamin E such as vitamin E acetate); vitamins A and B-carotene; fruit extracts or concentrates; panthenol and aloe; antipruritic/counterirritant materials; antimicrobial/keratolytic materials; anti-inflammatory agents; and astringents.

Enough shaving aid should be included to provide the desired benefit. The shaving aid matrix may contain, for example, between about 15% and about 85% (e.g., between about 20% and about 80%, more preferably between about 40% and about 75%), by weight of a lubricous water-soluble polymer. The shaving aid matrix also may include, for example, between about 0.01% and about 5.0% (e.g., between about 0.05% and about 1.0%), vitamin E (or common forms of vitamin E) by weight.

A preferred lubricous water-soluble polymer is polyethylene oxide. Suitable polyethylene oxides include those sold under the trade names POLYOX polymer (available from Dow Chemical) and ALKOX polymer (available from Meisei Chemical Works, Kyoto, Japan). These polyethylene oxides will preferably have molecular weights between about 100,000 and about 6 million, most preferably between about 300,000 and about 5 million. The most preferred polyethylene oxide comprises a blend of between about 40% and about 80% polyethylene oxide having an average molecular weight of about 5 million (e.g., POLYOX COAGULANT) and between about 60% and about 20% of polyethylene oxide having an average molecular weight of about 300,000 (e.g., POLYOX WSR-N-750 polymer). The polyethylene oxide blend may also advantageously contain up to about 10% by weight of a low molecular weight (i.e., MW<10,000) polyethylene glycol such as PEG-100 or Carbowax 4600.

While shown above the blades in the shaving cartridge of FIG. 1, shaving aid composite 22 may be located at any skin-engaging portion of the shaving unit (e.g., in locations other than the cartridge) and may be fabricated in any size or shape deemed appropriate. For example, the composite can be included in the shaving units described in U.S. Pat. No. 4,586,225, which is incorporated by reference herein.

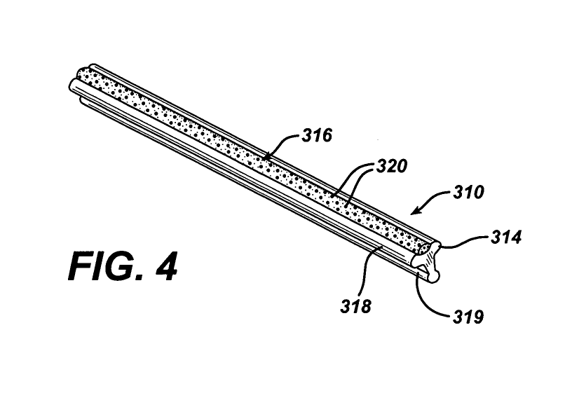

FIG. 4 shows a shaving aid composite 310 having a geometry similar to those described in U.S. Pat. No. 5,956,848, the entire contents of which are incorporated by reference herein. Shaving aid composite 310 includes portions 314 and 318, and connecting portion 319. Portions 314 and 318 include a water-insoluble polymer and a shaving aid. Shaving aid composite 310 further includes a central portion 316 with a polymeric matrix in which are embedded exfoliating elements 320. The polymeric matrix of central portion 316 includes a water-insoluble polymer and a colorant, and may optionally further include a shaving aid and/or other additives.

In some embodiments, as in FIG. 4, central portion 316 includes exfoliating elements, while portions 314 and 318 do not. In other embodiments, portions 314 and 318 have exfoliating elements, while central portion 316 does not. In still other embodiments, portions 314, 316, and 318 all include exfoliating elements. In some cases, one of portions 314 and 318 includes exfoliating elements, while the other portion does not.

The shaving aid composite may be fabricated by any appropriate method, including injection molding and extrusion.

As an example, the shaving aid composite may be formed by an injection molding process, using, for example, a ten-ton injection molding machine (e.g., a Van Dom 80). The injection molding process can be used to mold a shaving aid composite that is attached to a shaving cartridge, and/or to mold a shaving aid composite that is integral with a shaving cartridge. In some embodiments, the melt temperature can be from about 280° F. to about 360° F. The injection pressure can be from about 500 psi to about 800 psi, and/or the cycle time can be about 50 seconds. The mold temperature can be about 100° F., and/or the water temperature can be about 90° F. The injection speed can be about one millimeter per second.

As another example, the shaving aid composite may be formed in a single extrusion process. In this case, the exfoliating elements and the shaving aid matrix material are mixed together and extruded simultaneously, forming a shaving aid composite with abrasive elements distributed throughout its lubricating or moisturizing matrix. During the process, the exfoliating elements are loaded into the extruder at between about 0.01% by weight and about 50% by weight (e.g., between about 4% by weight and about 10% by weight). The continuous strand of shaving aid composite that is produced by the extrusion process is cut into inserts and then mounted onto razor cartridges.

If thermally sensitive chemical exfoliants are used in the extrusion process, it may be desirable to use matrix materials that can be processed at relatively low temperatures (e.g., polyethylene).

Alternatively, the shaving aid composite of FIG. 2 can be made by extruding and calendering a sheet of the polymeric matrix composition, and mechanically pressing the exfoliating elements into the sheet during or after calendering. The sheets are then cut to size to be used on a razor cartridge.

Another process for producing the shaving aid composite of FIG. 2 involves casting the polymer matrix containing the exfoliating elements in a mold. In such a process, the shaving aid matrix material and the exfoliating elements are mixed under heat to form a molten mixture, and are then poured into a mold with a desired shape. The resulting shaving aid composite is then removed from the mold and mounted on a shaving cartridge.

The shaving aid composite of FIGS. 3-3B may be formed, for example, using a coextrusion process. A coextrusion apparatus, typically including two extruders, is used to coextrude a layer including exfoliating elements with a layer including shaving aid matrix material, such that the exfoliating layer is on top of a portion of the shaving aid matrix layer, or is adjacent to the shaving aid matrix layer.

The extruders can operate at the same or different speeds and at the same or different temperatures. The barrel temperature for each extruder can be ramped in three zones from about 325° F. to about 375° F.; a fourth heater at the die/barrel connection can also be set to about 375° F., and a fifth heater at the die can range from about 375° F. to about 400° F. Both materials exit the die head in a size and shape approximating that of the final product. The final dimensions are determined with a sizing/cooling device which uses a series of forming rollers to form the final product as the extrudate is cooled. The shaving aid composite is typically extruded at a rate of about 50 feet per minute.

Once cool, the composite can be cut to the appropriate length and attached to a razor cartridge.

### EXAMPLE 1

A shaving aid composite was made, including a single extruded strip in which exfoliating particles were distributed throughout. The composite had the following composition:

| Component | Percentage of Total |
|---|---|
| Dow Polyox N750 | 25.2% |
| Dow Polyox Coag. | 32.8% |
| PCL White Color Conc. | 1.20% |
| BASF 495F | 25.5% |
| Carbowax 4600 PEG | 5.0% |
| B215 Irganox | 0.25% |
| Apricot seed powder | 10.0% |
| (med.-fine 60-150 mesh) | |
| Total | 100% |

### EXAMPLE 2

A coextruded shaving composite was made, including a colored exfoliating stripe material and a white non-exfoliating base material. In this example the exfoliating portion contained a shaving aid (Polyox).

| Component | Exfoliating Portion | Base Portion |
|---|---|---|
| Polyox N750 | 11.80% | 25.20% |
| Polyox Coag. | 19.66% | 37.81% |
| White Color Conc. | 23.5% | 1.20% |
| BASF 495F | 28.29% | 30.54% |
| Carbowax 4600 PEG | 5.00% | 5.00% |
| B215 Irganox Antioxidant | 0.25% | 0.25% |
| Apricot seed powder | 10.0% | |
| (med.-fine 60-150 mesh) | | |
| Blue color concentrate | 1.50% | — |
| TOTAL | 100.00% | 100.00% |

Other Embodiments

Other embodiments are possible.

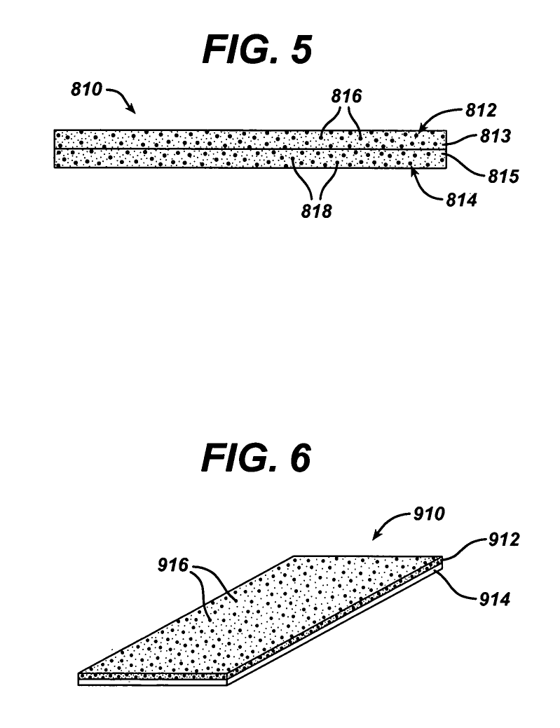

As shown in FIG. 5, a shaving aid composite 810 can include portions 812 and 814. Portions 812 and 814 can be adjacent to each other, as shown, or one portion can be partially on top of the other portion. Portion 812 includes a polymeric matrix 813 and exfoliating elements 816. Portion 814 includes a polymeric matrix 815 and exfoliating elements 818. Exfoliating elements 816 can be the same material as exfoliating elements 818, or they can be different materials. Portions 812 and 814 can each include a shaving aid, or only one or the other can include a shaving aid. If a shaving aid is included in each of the portions, the shaving aid in one portion can be the same as or different from the shaving aid in the other portion.

In some embodiments, a shaving aid composite can include two portions, where one portion overlies substantially all of a surface of the other portion. For example, in FIG. 6 a shaving aid composite 910 includes a first layer 912 and an underlying second layer 914. When shaving aid composite 910 is mounted on a razor cartridge, it is mounted such that layer 912 is the exposed layer (i.e., the skin-contacting layer). Layers 912 and 914 both contain a shaving aid matrix. Layer 912 also includes exfoliating elements 916. Layer 912 includes one colorant (e.g., a green pigment or dye), while layer 914 includes another, different, colorant (e.g., a yellow pigment or dye). In some cases, layer 914 also includes exfoliating elements.

The exfoliating elements can be microcapsules containing, e.g., shaving aids such as moisturizers, or moisturizers combined with fragrances. The microcapsules can break upon usage, releasing the shaving aids. In some embodiments, the microcapsules themselves may serve as exfoliating elements. The capsules themselves, either as is, or after breaking to release their contents, may be of a size, shape or roughness suitable for exfoliation. The exfoliating microcapsules can contain another exfoliating element. The microcapsules can have walls that are thick enough to help keep oxygen out of the microcapsules during, e.g., an extrusion process. The microcapsules can be, for example, cellulose- or polyurethane-based.

In some embodiments, the exfoliating elements are coated with at least one other shaving aid, such as an oil or vitamin. In such cases, the shaving aid matrix should include an amount of a water-soluble lubricant (e.g., Polyox) in the matrix that is sufficient to help deliver the shaving aid to the user's skin during shaving. For example, if an oil is coated on an exfoliating particle, and the particle stays in the strip, then the oil may not be delivered to the skin. In the presence of a water-soluble lubricant, however, any oil displaced from the exfoliating particle may be more easily delivered to the skin.

The exfoliating elements can be water soluble or partially water soluble, such that they dissolve after a certain period of time or use. The exfoliating elements can be colored to, for example, indicate their composition to the user. A green exfoliating element can signal to the user that the element contains vitamin E, or a blue exfoliating element can signal lanolin content.

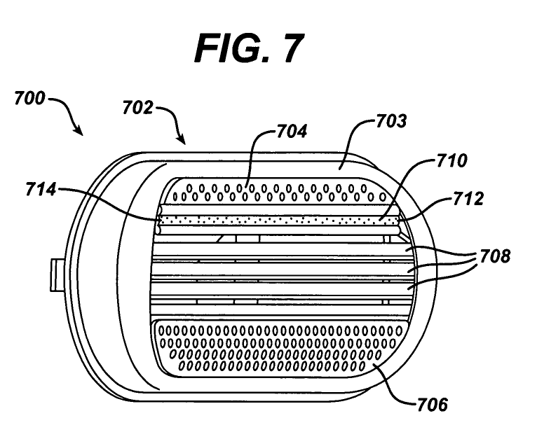

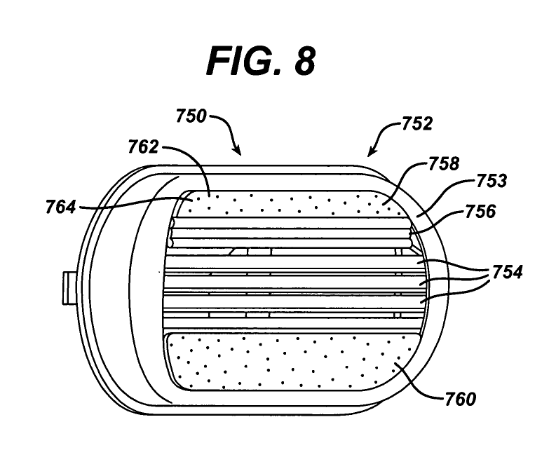

The shaving aid composite can be used in different types of wet shaving systems (e.g., wet shaving systems having different configurations). For example, FIG. 7 shows a wet shaving system 700 that includes a cartridge 702 with a housing 703, a cap 704, a guard 706, and blades 708. A shaving aid composite 710, including a shaving aid matrix 712 and exfoliating elements 714, is located between cap 704 and blades 708. FIG. 8 shows a wet shaving system 750 including a cartridge 752 with a housing 753, blades 754, and a shaving aid composite 756 that does not include exfoliating elements. Wet shaving system 750 further includes two shaving aid composites 758 and 760, each of which includes a shaving aid matrix 762 and exfoliating elements 764. Wet shaving systems are further described in Brown et al., U.S. Pat. No. 6,185,823, which is incorporated herein by reference in its entirety.

The shaving aid composite can be used in different locations on a razor cartridge. It can be used on the guard, cap, and/or clips to achieve simultaneous exfoliation and lubrication. The shaving aid composite can be attached to the wet shaving system (e.g., by snapping and/or gluing the shaving aid composite into the cartridge). For example, the shaving aid composite can be in the form of a strip that can be attached to the razor cartridge by, for example, gluing the strip to the cartridge or snapping the strip into a recess in the cartridge. In some embodiments, the shaving aid composite can be located on a portion of the cartridge that is configured to connect the cartridge with a handle.

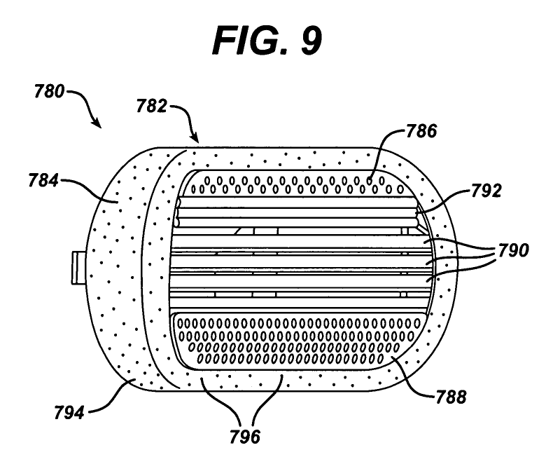

In some embodiments, all or a portion of the cartridge housing of a wet shaving system can be formed of a shaving aid composite. Referring to FIG. 9, a wet shaving system 780 includes a cartridge 782 with a housing 784, guards 786 and 788, blades 790, and a shaving aid composite 792 that does not include exfoliating elements. Cartridge housing 784 is formed of a shaving aid composite that includes a shaving aid matrix 794 and exfoliating elements 796. Cartridge housing 784 can be formed, for example, using an injection molding process.

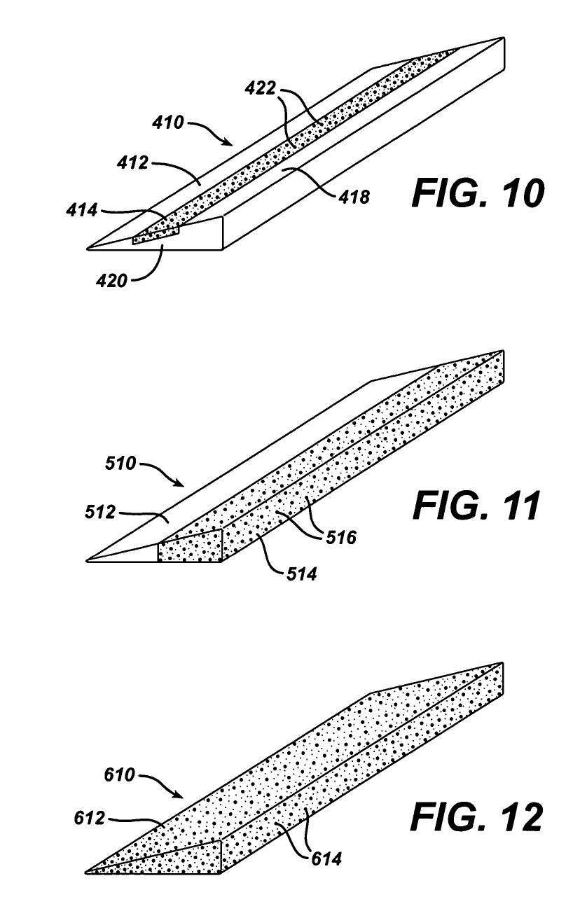

Referring now to FIGS. 10-12, in some embodiments the shaving aid composite can be generally wedge-shaped. The wedge can be attached to a shaving cartridge by, e.g., gluing. In FIG. 10, a wedge-shaped shaving aid composite 410 includes lengthwise-extending portions 412, 414, and 418, each including a lengthwise-extending exposed surface. Shaving aid composite 410 also includes connection portion 420. Portions 412, 414, and 418 may each include a shaving aid matrix (i.e., a water-insoluble polymer and a shaving aid). The shaving aid matrix in each portion may be different from those in the other portions, or may be the same. In FIG. 10, portion 414 includes exfoliating elements 422.

In FIG. 11, a shaving aid composite 510 includes two lengthwise-extending portions 512 and 514. Portion 514 includes exfoliating elements 516. Portions 512 and 514 can each include a shaving aid matrix.

In FIG. 12, a shaving aid composite 610 includes a shaving aid matrix 612 and exfoliating elements 614.

While in the embodiment described above with reference to FIG. 3A, at least one of the portions 322, 328, and 330 contains a shaving aid, alternatively the shaving aid can be provided only in the exfoliating portion 226 and portions 322, 328, and 330 can be substantially free of shaving aid.

In some embodiments, a shaving aid composite that contains exfoliating elements can be adjustable. Adjustable exfoliation members (including, e.g., a shaving aid matrix with a shaving aid) are described, for example, in U.S. patent application Ser. No. 10/732,555, filed on Dec. 10, 2003, and entitled “Shaving Systems”, which is incorporated herein by reference in its entirety.

In some embodiments, a shaving aid composite can include an exfoliating material, in addition to, or as an alternative to, exfoliating elements. For example, a shaving aid composite can include a shaving aid matrix (containing a water-insoluble polymer such as polystyrene, and a shaving aid such as polyethylene oxide) that is molded over an exfoliating material. The exfoliating material can be, for example, a mesh or net material (such as nylon netting), and/or a woven or non-woven material (such as a hard sponge or scrubbing pad composition). Alternatively or additionally, the exfoliating material can be embedded into a skin-engaging portion of the shaving aid composite.

Other embodiments are within the scope of the following claims.

What is claimed is:

1. A wet shaving system comprising:
a blade member; and
a skin-engaging portion including a shaving aid composite comprising
a shaving aid matrix including a polymer and a shaving aid, and
a plurality of exfoliating elements embedded in the shaving aid matrix.

2. The wet shaving system of claim 1, wherein the polymer comprises a water-insoluble polymer.

3. The wet shaving system of claim 1, wherein the polymer is selected from the group consisting of polyethylene, polypropylene, polystyrene, butadiene-styrene copolymer, polyacetal, nylon, polycaprolactone, acrylonitrile-butadiene-styrene copolymer, polycarbonate, polyurethane, and ethylene vinyl acetate copolymer.

4. The wet shaving system of claim 1, wherein the shaving aid composite further comprises a colorant.

5. A wet shaving system comprising:
a blade member; and
a skin-engaging portion including a shaving aid composite comprising
a first section comprising a first polymer and a plurality of exfoliating elements embedded in the first polymer, and
a second section comprising a second polymer,
wherein at least one of the first section or second section further comprises a shaving aid.

6. The wet shaving system of claim 1 or claim 5, wherein the exfoliating elements comprise a member selected from the group consisting of fruit seeds, fruit stones, nut shells, ground or fibrous plant material, polymers, and mineral composites.

7. The wet shaving system of claim 1 or claim 5, wherein the exfoliating elements comprise a member selected from the group consisting of ground coconut shell, ground apricot seeds, ground peach seeds, ground olive seeds, ground walnut shell, ground almond shell, ground pecan shell, ground luffa, corn cob granules, ground oatmeal, polymer beads or granular polymers, Jojoba wax beads, rice bran, silica, sand, or other minerals, pumice sand, clay, and combinations thereof.

8. The wet shaving system of claim 1 or claim 5, wherein the exfoliating elements comprise microcapsules, each microcapsule defining an external surface and an internal volume.

9. The wet shaving system of claim 8, wherein a chemical exfoliant is disposed within the internal volumes of the microcapsules.

10. The wet shaving system of claim 9, wherein the chemical exfoliant comprises an alpha-hydroxy acid.

11. The wet shaving system of claim 9, wherein the chemical exfoliant comprises a beta-hydroxy acid.

12. The wet shaving system of claim 1 or claim 5, wherein the external surfaces of the microcapsules comprise an exfoliant.

13. The wet shaving system of claim 1 or claim 5, wherein the shaving aid comprises polyethylene oxide.

14. The wet shaving system of claim 1 or claim 5, wherein the shaving aid comprises a member selected from the group consisting of vitamin E, aloe, baby oil, avocado oil, grape seed oil, and sweet almond oil.

15. The wet shaving system of claim 1 or claim 5, wherein the exfoliating elements comprise a colorant.

16. The wet shaving system of claim 5, wherein at least one of the first polymer or the second polymer comprises a water-insoluble polymer.

17. The wet shaving system of claim 5, wherein the second section comprises a plurality of exfoliating elements embedded in the second polymer.

18. The wet shaving system of claim 5, wherein both the first section and the second section comprise a shaving aid.

19. The wet shaving system of claim 5, wherein the first section comprises a shaving aid.

20. The wet shaving system of claim 5, wherein the second section comprises a shaving aid.

21. The wet shaving system of claim 5, wherein at least one of the first or second water-insoluble polymers is selected from the group consisting of polyethylene, polypropylene, polystyrene, butadiene-styrene copolymer, polyacetal, acrylonitrile-butadiene-styrene copolymer, and ethylene vinyl acetate copolymer.

22. The wet shaving system of claim 5, wherein the first section is on top of the second section.

23. The set shaving system of claim 5, wherein the first section is laterally adjacent to the second section.

24. The wet shaving system of claim 5, wherein the first and second sections are different colors.

25. The wet shaving system of claim 5, wherein at least one of the first section or second section further comprises a colorant.

26. A shaving aid composite comprising:
a shaving aid matrix including
a polymer,
a shaving aid, and
a plurality of exfoliating elements,
wherein the exfoliating elements are embedded in the shaving aid matrix.

27. The shaving aid composite of claim 26, wherein the polymer comprises a water-insoluble polymer.

28. A shaving aid composite comprising:
a first section comprising a first polymer and a plurality of exfoliating elements embedded in the first polymer; and
a second section comprising a second polymer,
wherein at least one of the first section or the second section further comprises a shaving aid.

29. The shaving aid composite of claim 28, wherein at least one of the first polymer or the second polymer comprises a water-insoluble polymer.

30. A shaving aid composite comprising:
a water-insoluble polymer;
a shaving aid; and
a plurality of exfoliating elements.

31. The shaving aid composite of claim 30, wherein the shaving aid and the exfoliating elements are disposed in a single layer.

32. The shaving aid composite of claim 30, wherein the shaving aid is disposed in a first portion of the water-insoluble polymer, and wherein the exfoliating elements are disposed in a second portion of the water-insoluble polymer.

33. A wet shaving system comprising:
a blade member; and
a skin-engaging portion including a shaving aid composite comprising
a shaving aid matrix including a polymer and a shaving aid, and
an exfoliating material.

34. The wet shaving system of claim 33, wherein the exfoliating material comprises a mesh or net material.

35. The wet shaving system of claim 33, wherein the exfoliating material is embedded in a skin-engaging portion of the shaving aid matrix.

36. The wet shaving system of claim 33, wherein the shaving aid matrix is molded over the exfoliating material.
